(19) United States
(12) Patent Application Publication
(10) Pub. No.: US 2006/0010486 A1
(43) Pub. Date: Jan. 12, 2006

(54) NETWORK SECURITY ACTIVE DETECTING SYSTEM AND METHOD THEREOF

(76) Inventors: Chih-Chung Lu, Taipei City (TW); He-Ren Lin, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 10/904,542

(22) Filed: Nov. 16, 2004

(30) Foreign Application Priority Data
Jul. 9, 2004 (TW) 093120531

(51) Int. Cl. G06F 15/16; G06F 17/30; G06F 7/04; G06F 7/58; G06K 19/00; G06K 9/00; H04L 9/32; H04L 9/00

(52) U.S. Cl. 726/4; 713/166

(57) ABSTRACT

A network security active detecting system for connecting to at least one client end and a server end in a network system includes a networking-judging unit for judging whether a networking request of a client end is sent to an authorized network, a security condition detecting unit for determining the security level of the client end after the networking-judging unit confirms the networking request of the client end is sent to the authorized network, a configuration exchange unit for controlling the client and server ends to negotiate for a communication protocol identified during the networking so as to determine a security service routine, a Layer 3 packet process unit for processing packets transmitted between the client end and the server end with the security service routine according to the communication protocol, and a negotiating mechanism for confirming the networking between the client and server ends for releasing system resources.

### BACKGROUND OF INVENTION

1. Field of the Invention

The present invention relates to a network security active detecting system and a method thereof, and more particularly, to a network security active detecting system and a method thereof capable of providing a proper service according to a security condition of a client end.

2. Description of the Prior Art

With the rapid development of network technology, packets loaded private information such as confidential data, personal ID, and password, can be easily and quickly transmitted through a public network system (e.g. the Internet). However, a cunning hacker is able to intrude and intercept the data from the public-used network system. Therefore, it is a very important topic for maintaining the safety of transmitted data over the public-used network. Nowadays, various types of Internet appliances (IA) such as security gateways, routers, or firewall devices are developed. Through the use of a specific security standard (e.g. FTP, HTTP or Telnet etc.), such Internet appliances disposed at either a client end or a server end of the network system can provide the security on the data transmitted across the network system.

If there are more network security mechanisms or devices to provide the security service, such as an encryption/decryption service, a digital signature service, or a packet filter service, the transmission of the network system is more reliable, but more network bandwidth would be occupied so that the process efficiency of the system would be reduced. In addition, there are common ways to provide all kinds of security services. One is installing the driven program on the operating system, and the other is utilizing a router gateway to control input/output of packets. The former one would increase the complexity and decrease the stability of the system, and it is not convenient for maintenance of a public machine, such as a public notebook. The latter one would require modifying the network architecture. For example, when a machine with a public IP connected to the Internet directly is connected to the router gateway, the IP address of the machine needs to be modified so that the security service, such as an encryption/decryption service with tunneling, is more complicated.

For client-server network architecture, any client end could request to download data from a server end. Or for peer-to-peer network architecture, a receiving end could request to download music or image data from a providing end. When multiple client ends ask to connect with a server end for downloading data, the server end has to provide the security service for every client end, even for a non-malicious client end, causing the network to be jammed and causing the efficiency of the server end to decrease.

### SUMMARY OF INVENTION

It is therefore a primary objective of the present invention to provide a network security active detecting system and a method thereof to solve the problem mentioned above. The network security active detecting system and method are for use in a network architecture with a server end and a client end, such as a client-to-server or a peer-to-peer network architecture. The present invention utilizes a Layer 2 Bridge of the TCP/IP protocol instead of modifying the IP address of Layer 3, and processes a data payload of Layer 3 of the packet to operate a security service routine so as to increase the communication transparency. Users still can keep original networking methods instead of changing the network architecture to connect to a router gateway and modifying the IP address, so the system would not become complicated and unstable.

Furthermore the present invention provides a network security active detecting system and a method thereof. The network security active detecting system and method are for use in a network architecture with a server end and a client end, such as a client-to-server or a peer-to-peer network architecture. When a networking request of a client end is sent to an authorized network, the network security active detecting system determines the security level of the client automatically. When confirming that the security level of the client end is high, the two network security active detecting systems of the server end and the client end negotiate for a communication protocol with a security service setting value so as to determine a security service routine for packets transmitted between the client end and the server end. When confirming that the security level of the client end is low, a Layer 2 bridge sends out the packet transmitted from the client end directly without processing. So the present invention can provide the proper security service routine for the packet transmitted between the client end and the server end according to the security level instead of providing security service for every client end which requests to connect in the prior art. The present invention can improve the jammed problem of network and increase the efficiency of the system.

According to the claimed invention, a network security active detecting system for connecting to at least one client end and a server end in a network system includes a networking-judging unit for judging whether a networking request of a client end is sent to an authorized network, a security condition detecting unit for determining the security level of the client end after the networking-judging unit confirms the networking request of the client end is sent to the authorized network, a configuration exchange unit for controlling the client end and the server end to negotiate for a communication protocol identified during the networking so as to determine a security service routine, a Layer 3 packet process unit for processing packets transmitted between the client end and the server end with the security service routine according to the communication protocol, and a negotiating mechanism for confirming the networking between the client end and the server end so as to release system resources.

According to the claimed invention, a network security active detecting method used in a network system connecting to at least one client end and a server end includes utilizing a security condition detecting unit to determine the security level of the client end according to initial networking between the client end and the server end, negotiating for a communication protocol identified during the networking between the client end and the server end so as to determine a security service routine when confirming that the security level of the client end is high, processing the packet transmitted between the client end and the server end in the security service routine according to the communication protocol, and confirming the networking between the client end and the server end so as to release system resources.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a functional block diagram of a network security active detecting system according to a preferred embodiment of the present invention.

FIG. 2 is a flowchart of the network security active detecting method according to a preferred embodiment of the present invention.

FIG. 3 illustrates initial networking.

FIG. 4 illustrates the operating principle of the packet process mechanism.

FIG. 5 is a diagram of a three-way handshaking networking between a network security active detecting system for a client end and a server end according to a first embodiment of the present invention.

FIG. 6 is a diagram of a three-way handshaking networking between a client end and a network security active detecting system for a server end according to a second embodiment of the present invention.

FIG. 7 is a diagram of a three-way handshaking networking between a network security active detecting system for a client end and a network security active detecting system for a server end according to a third embodiment of the present invention.

FIG. 8 is a diagram of a three-way handshaking networking between a network security active detecting system for a client end and a network security active detecting system for a server end according to a fourth embodiment of the present invention.

### DETAILED DESCRIPTION

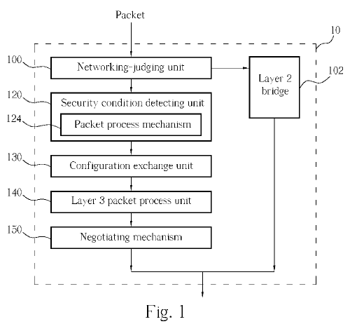

Please refer to FIG. 1. FIG. 1 is a functional block diagram of a network security active detecting system 10 according to a preferred embodiment of the present invention. The network security active detecting system 10 is used in a network with at least one client end and a server end. The network security active detecting system 10 includes a networking-judging unit 100, a Layer 2 bridge, a security condition detecting unit 120, a configuration exchange unit 130, a Layer 3 packet process unit 140, and a negotiating mechanism 150. And the network security active detecting system 10 further includes at least one active bridge of the preferred embodiment adjacent to the client end or the server end.

The networking-judging unit 100 of the network security active detecting system 10 can judge whether an initial networking request of a client end is sent to an authorized network with a check table. The check table records every authorized networking data beforehand including a Layer 2 MAC address of the client, a Layer 3 IP address, or a Layer 4 service port number. When the networking-judging unit 100 determines that the networking request of the client end is not sent to the authorized network, any packet transmitted from the client end will be recorded and a Layer 2 bridge will send out the packet transmitted from the client end directly without processing.

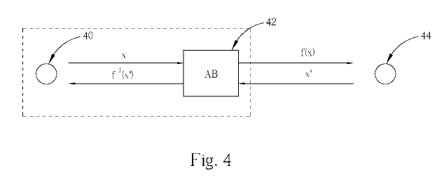

The security condition detecting unit 120 includes a packet process mechanism 124 for dealing with an operation of the initial networking between the client end and the server end when the networking-judging unit 100 confirms that the networking request of the client end is sent to the authorized network. Please refer to FIG. 4. FIG. 4 illustrates the operating principle of the packet process mechanism 124. The packet process mechanism 124 can operate a function f(X) for an identification X of a head of the packet transmitted from a network security active detecting system 32 and operate an inverse function f⁻¹(X′) for an identification X′ of a head of the packet received by the network security active detecting system 42 during the networking between a client end 40 and a server end 44. The security condition detecting unit 120 will determine the security level of the client end 40 according to the comparison between the operating result of f⁻¹(X′) and a predetermined progressive value (SN+1). If the operating result of f⁻¹(X′) is equal to the predetermined progressive value (SN+1), the security of the client end is high. That is, the client end 40 includes the network security active detecting system 10 corresponding to the network security active detecting system 32. On the contrary, if the operating result of f⁻¹(X′) is not equal to the predetermined progressive value (SN+1), the security of the client end is low. That is, the client end 40 does not include the network security active detecting system 10 corresponding to the network security active detecting system 32. The derivation of the predetermined progressive value (SN+1) will be described later.

The packet process mechanism 124 of the security condition detecting unit 120 operates the function f(X) for the identification of the head of the packet so that information of the packet will not be erased after being transmitted between several network apparatuses. There is a serial number in the 16-bit identification field of the IP head for sequence identification of the single packet. That is, the serial number will be added by 1 after the client end/the server end sends out a packet. So the predetermined progressive value (SN+1) is derived from the above principle. Because the field is not used frequently, the information of the network security active detecting system can be stored in the field.

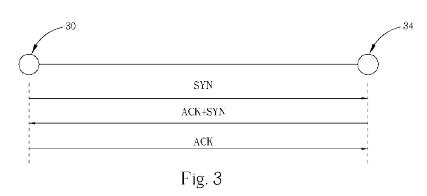

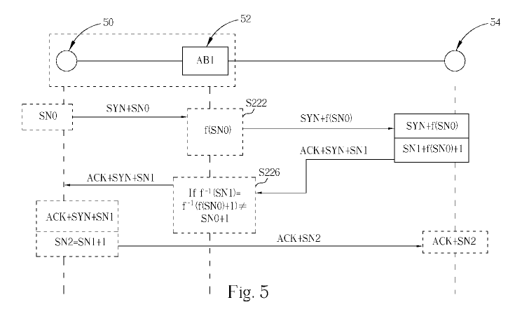

Please refer to FIG. 3. FIG. 3 illustrates initial networking. The initial networking corresponding with TCP/IP between a client end 30 and a server end 34 is a three-way handshaking networking for transmitting SYN packets, ACK+SYN packets, and ACK packets. The handshaking is used to establish pre-communication between the client end 30 and the server end 34 before the initial networking so that the networking can be confirmed and the identity of the respective protocols can be confirmed. In the embodiment of the present invention the operation of the initial networking between the client end and the server end processed by the packet process mechanism 124 of the security condition detecting unit 120 is illustrated in FIG. 5, 6, 7, 8 instead of the initial networking in FIG. 3.

The configuration exchange unit 130 can control the client end and the server end to negotiate for a communication protocol so as to get setting details of the respective network security active detecting systems from each other when the security condition detecting unit 120 determines that the security level of the client end is high. For example, the three-way handshaking networking can ensure that the client end and the server end can share information with each other via the designated packet in consideration of the time out problem and the retransmission problem. In addition, the detailed information of the networking can be stored in the packet in a manner dependent on the communication type. The detailed information carried in the packet can be a security service setting value corresponding with the protocol identified by the client end and the server end, which is used in a security service routine, such as an encryption/decryption service, a digital signature service, or a pattern match service. For example, the security service setting value used in the encryption/decryption service can be an encryption algorithm and a corresponding enciphering/deciphering key.

The Layer 3 packet process unit 140 processes packets transmitted between the client end and the server end with the security service routine according to the communication protocol. That is, the Layer 3 packet process unit 140 processes a data payload of the Layer 3 of the packet transmitted between the client end and the server end according to the security service setting value when the Layer 3 packet process unit 140 operates the security service routine. The network security active detecting system receives the packet of the non-authorized network from a network port. And then the network security active detecting system sends out the packet of the non-authorized network via a Layer 2 bridge (TCP/IP layer 2 bridge) 102 after the packet of the non-authorized network is checked on layer 2 and is not processed on layer 3. This is because the network security active detecting system 10 cannot disclose the IP address of layer 3 and processes the data after the head of the packet on layer 3. That is, the network security active detecting system 10 processes the data above the layer 3 payload. The network security active detecting system according to the present invention builds up a tunnel on layer 3 with agent identification and sends back the packet, and the network security active detecting system sends out the packet via the tunnel in the opposite direction.

For a session oriented networking, such as TCP/IP, when the networking session is going to close, the action of the network security active detecting system is terminated. For a non-session oriented networking, such as UDP, the termination of the network security active detecting system depends on a time-out mechanism. For example, when there is no packet flowing through the network security active detecting system during a predetermined period, the action of the network security active detecting system is terminated. And then the network security active detecting system would activate the negotiating mechanism 150 to confirm the networking between the client end and the server end so as to release system resources.

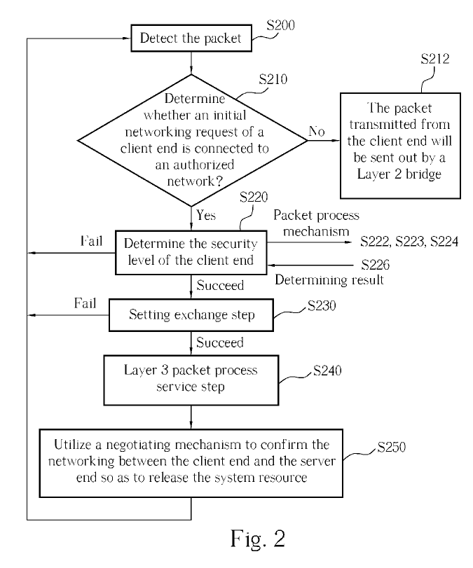

Please refer to FIG. 2. FIG. 2 is a flowchart of the network security active detecting method according to a preferred embodiment of the present invention. The network security active detecting method is used in a network with at least one client end and a server end. And the network system includes at least one active bridge adjacent to the client end or the server end. The method includes the following steps:

Step 200: Detect the packet transmitted between the client end and the server end.

Step 210: Utilize a networking-judging unit 100 to determine whether an initial networking request of a client end is sent to an authorized network.

Step 212: When the networking-judging unit 100 determines that the networking request of the client end is not sent to the authorized network, any packet transmitted from the client end will be sent out by a Layer 2 bridge. On the contrary, when the networking-judging unit 100 determines that the networking request of the client end is sent to the authorized network, go to step 220.

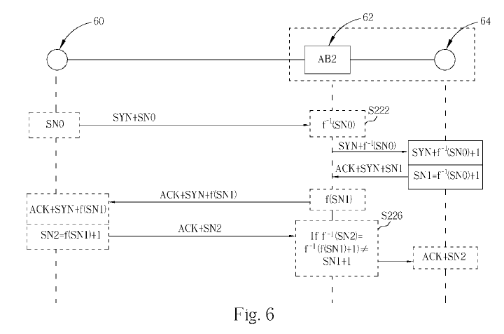

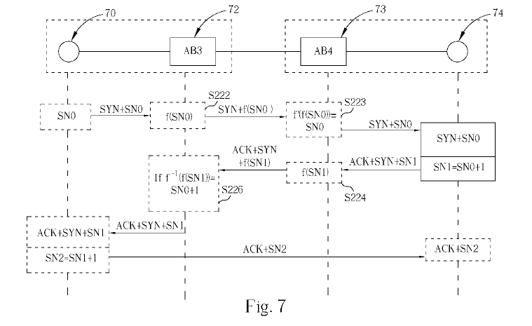

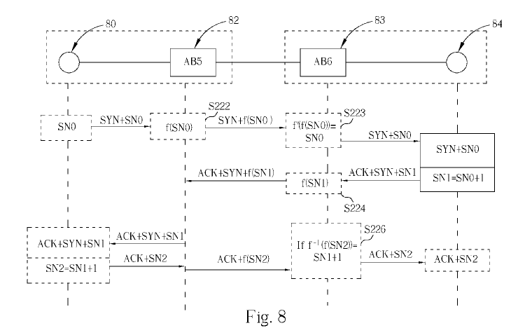

Step 220: Utilize a security condition detecting unit to determine the security level of the client end. The security condition detecting unit processes a packet process mechanism shown in step 222, step 223, and step 224 in FIG. 5, FIG. 6, FIG. 7, and FIG. 8. That is, the packet process mechanism operates a function for an identification of a head of the packet transmitted from the security condition detecting unit and operates an inverse function for an identification of a head of the packet received by the security condition detecting unit. And then the security condition detecting unit will operate the actions shown in FIG. 5, FIG. 6, FIG. 7, and FIG. 8. The security condition detecting unit determines the security level of the client end according to the comparison between the operating result of the identification of the head of the packet and a predetermined progressive value. If the operating result is equal to the predetermined progressive value, the security of the client end is high. On the contrary, if the operating result is not equal to the predetermined progressive value, the security of the client end is low. Step 220 is an active detection step.

Step 230: Utilize a configuration exchange unit 130 to control the client end and the server end to negotiate for a communication protocol identified during the networking so as to determine a security service routine when the security condition detecting unit confirms that the security of the client end is high. Step 230 is a setting exchange step.

Step 240: Utilize a Layer 3 packet process unit 140 to process a data payload on Layer 3 of the packet transmitted between the client end and the server end with the security service routine according to a security service setting value of the communication protocol. Step 240 is a Layer 3 packet process service step.

Step 250: Utilize a negotiating mechanism 150 to confirm the networking between the client end and the server end so as to release system resources. When the initial networking is terminated, go to step 200 and process the next packet of the initial networking.

Please refer to FIG. 5. FIG. 5 is a diagram of a three-way handshaking networking between a network security active detecting system 52 for a client end 50 and a server end 54 according to a first embodiment of the present invention. When the client end 50 sends a packet with a SYN message and an identification SN0 of a head, the network security active detecting system 52 will operate the packet process mechanism in step 222. That is, a function f(SN0) is operated, and a packet with the SYN message and f(SN0) relative to the identification of the head will be transmitted to the server 54. After the server end 54 receives the packet, a progressive value SN1 (SN1=f(SN0)+1) is derived from f(SN0) being added by 1. And then the server end 54 will reply with a packet containing an ACK and SYN message and an identification SN1 of a head. When the network security active detecting system 52 receives the packet with ACK+SYN+SN1 message, step 226 will be processed. That is, an inverse function f⁻¹(SN1) is operated, and then the operating result of f⁻¹(SN1) is compared with a predetermined progressive value SN0+1. If the operating result of f⁻¹(X′) is not equal to the predetermined progressive value SN0+1, that means a corresponding network security active detecting system is not installed in the server end 54 so that the security level is low. Therefore the network security active detecting system 52 for the client end 50 only transmits the packet with ACK+SYN+SN1 message to the network security active detecting system 52 without other processing, and then the client end 50 will add SN1 by 1 to SN2 and transmit the packet with ACK+SN2 message to the server end 54 to end the networking.

Please refer to FIG. 6. FIG. 6 is a diagram of a three-way handshaking networking between a client end 60 and a network security active detecting system 62 for a server end 64 according to a second embodiment of the present invention. After the client end 60 sends out a packet with a SYN message and an identification SN0 of a head, the network security active detecting system 62 for the server end 64 will operate the packet process mechanism in step 222. That is, an inverse function f⁻¹(SN0) is operated, and a packet with the SYN message and f⁻¹(SN0) relative to the identification of the head will be transmitted to the server 64. After the server end 64 receives the packet, a progressive value SN1 (SN1=f⁻¹(SN0)+1) is derived from f⁻¹ (SN0) being added by 1. And then the server end 64 will reply with a packet containing an ACK and SYN message and an identification SN1 of a head. When the network security active detecting system 62 receives the packet with ACK+SYN+SN1 message, a function f(SN1) is operated and a packet with the ACK+SYN+f(SN1) message will be transmitted to the client end 60. After the client end 60 receives the packet, SN2 is derived from f(SN1) being added by 1 (SN2=f(SN1)+1). And then a packet with ACK+SN2 message will be transmitted to the network security active detecting system 62. The network security active detecting system 62 will operate step 226. That is, an inverse function f⁻¹(SN2) is operated, and then the operating result of f⁻¹(SN2) is compared with a predetermined progressive value SN1+1. If the operating result of f⁻¹(SN2) is not equal to a predetermined progressive value SN1+1, that means a corresponding network security active detecting system is not installed in the client end 60 so that the security level is low. Therefore the network security active detecting system 62 for the server end 64 only transmits the packet with the ACK+SN2 message to the server end 64 without other processing to end the networking.

Please refer to FIG. 7. FIG. 7 is a diagram of a three-way handshaking networking between a network security active detecting system 72 for a client end 70 and a network security active detecting system 73 for a server end 74 according to a third embodiment of the present invention. After the client end 70 sends out a packet with a SYN message and an identification SN0 of a head, the network security active detecting system 72 for the client end 70 will operate the packet process mechanism in step 222. That is, a function f(SN0) is operated, and a packet with the SYN message and f(SN0) will be transmitted to the network security active detecting system 73 for the client end 74. After the server end 74 receives the packet, a progressive value SN1 (SN1=SN0+1) is derived from SN0 being added by 1. And then the server end 74 will reply with a packet containing an ACK+SYN+SN1 message. When the network security active detecting system 73 for the server end 74 receives the packet with the ACK+SYN+SN1 message, step 224 will be processed. That is, a function f(SN1) is operated, and a packet with the ACK+SYN+f(SN1) message will be transmitted to the network security active detecting system 72 for the client end 70. And then step 226 will be processed by the network security active detecting system 72 for the client end 70. That is, an inverse function f⁻¹(f(SN1)) is operated, and then the operating result of f⁻¹(f(SN1)), SN1, is compared with a predetermined progressive value SN0+1. If SN1 is equal to the predetermined progressive value SN0+1, that means a corresponding network security active detecting system is installed in the client end 70 so that the security level is high. Therefore the network security active detecting system 73 for the server end 74 starts to prepare the security service and transmits the packet with the ACK+SYN+SN1 message to the client end 70, and then the client end 70 will add 1 to SN1 to calculate SN2 (SN2=SN1+1) and transmit the packet with a ACK+SN2 message to the server end 74 to end the networking.

Please refer to FIG. 8. FIG. 8 is a diagram of a three-way handshaking networking between a network security active detecting system 82 for a client end 80 and a network security active detecting system 83 for a server end 84 according to a fourth embodiment of the present invention. The fourth embodiment is similar with the third embodiment. The difference between the fourth embodiment and the third embodiment is that the network security active detecting system 72 for the client end 70 is responsible for determining the security level in the third embodiment as shown in FIG. 7 and the network security active detecting system 82 for the client end 80 is responsible for determining the security level in the fourth embodiment as shown in FIG. 8. The other working principles of the third embodiment and the fourth embodiment are the same.

In the above-mentioned embodiments, the network security active detecting system and method thereof only processes the security service routine to the data payload of the packet on layer 3 instead of modifying the IP address on layer 3 so that the present invention can increase the communication transparency and so the system according to the present invention does not become complicated and unstable, no matter if it is used in a client-to-server network architecture or a peer-to-peer network architecture. Users still can keep original networking methods instead of changing the network architecture to connect to a router gateway and modifying the IP address, so the system does not become complicated and unstable. In addition, the network security active detecting system according to the present invention can detect the security level of the opposite networking end automatically and determine if the network security active detecting system operates a corresponding security service routine to the packet transmitted between the client end and the server end according to the security level. When the security level of the opposite networking end is low, a Layer 2 Bridge will send out the packet directly without processing. So the present invention can provide the proper security service routine for the packet transmitted between the client end and the server end according to the security level instead of providing security service for every client end. The present invention can improve the jammed problem occurring in the network and increase the efficiency of the system.

Following the detailed description of the present invention above, those skilled in the art will readily observe that numerous modifications and alterations of the device and the method may be made while retaining the teachings of the invention. Accordingly, the above disclosure should be construed as limited only by the metes and bounds of the appended claims.

What is claimed is:

1. A network security active detecting system for connecting to at least one client end and a server end in a network system comprising:
a networking-judging unit for judging whether a networking request of a client end is sent to an authorized network;
a security condition detecting unit for determining the security level of the client end after the networking-judging unit confirms the networking request of the client end is sent to the authorized network;
a configuration exchange unit for controlling the client end and the server end to negotiate for a communication protocol identified during the networking so as to determine a security service routine;
a Layer 3 packet process unit for processing packets transmitted between the client end and the server end with the security service routine according to the communication protocol; and
a negotiating mechanism for confirming the networking between the client end and the server end so as to release system resources.

2. The network security active detecting system of claim 1 wherein the networking-judging unit comprises a check table for recording every authorized networking data beforehand comprising a Layer 2 MAC address, a Layer 3 IP address, or a Layer 4 service port number.

3. The network security active detecting system of claim 1 wherein when the networking-judging unit determines that the networking request of the client end is not sent to the authorized network, a Layer 2 Bridge sends out the packet transmitted from the client end directly.

4. The network security active detecting system of claim 1 wherein the security condition detecting unit comprises a packet process mechanism for operating a function for an identification of a head of the packet transmitted from the network security active detecting system and operating an inverse function for an identification of a head of the packet received by the network security active detecting system during the initial networking between the client end and the server end.

5. The network security active detecting system of claim 4 wherein the initial networking between the client end and the server end is a three-way handshaking networking for transmitting SYN packets, ACK+SYN packets, and ACK packets.

6. The network security active detecting system of claim 4 wherein the security condition detecting unit determines the security level of the client end according to the comparison between an operating result of the identification of the head of the packet received by the network security active detecting system and a predetermined progressive value.

7. The network security active detecting system of claim 1 wherein the communication protocol negotiated by the client end and the server end comprises a security service setting value.

8. The network security active detecting system of claim 7 wherein the security service routine comprises an encryption/decryption service, a digital signature service, or a pattern match service.

9. The network security active detecting system of claim 7 wherein the Layer 3 packet process unit processes a data payload on Layer 3 of the packet transmitted between the client end and the server end according to the security service setting value when the Layer 3 packet process unit operates the security service routine.

10. A network security active detecting method for use in a network system connecting to at least one client end and a server end comprising:
utilizing a security condition detecting unit to determine the security level of the client end according to initial networking between the client end and the server end;
negotiating for a communication protocol identified during the networking between the client end and the server end so as to determine a security service routine when confirming that the security level of the client end is high;
processing the packet transmitted between the client end and the server end in the security service routine according to the communication protocol; and
confirming the networking between the client end and server end so as to release system resources.

11. The network security active detecting method of claim 10 further comprising utilizing a networking-judging unit for judging whether a networking request of the client end is sent to an authorized network.

12. The network security active detecting method of claim 11 wherein the networking-judging unit comprises a check table for recording every authorized networking data beforehand comprising a Layer 2 MAC address, a Layer 3 IP address, or a Layer 4 service port number.

13. The network security active detecting method of claim 11 wherein when the networking-judging unit determines that the networking request of the client end is not sent to the authorized network, a Layer 2 Bridge sends out the packet transmitted from the client end directly.

14. The network security active detecting method of claim 11 wherein when the networking-judging unit determines the networking request of the client end is sent to the authorized network, the initial networking between the client end and the server end is processed.

15. The network security active detecting method of claim 10 wherein the initial networking between the client end and the server end is a three-way handshaking networking for transmitting SYN packets, ACK+SYN packets, and ACK packets.

16. The network security active detecting method of claim 10 further comprising operating a function for an identification of a head of the packet transmitted from the security condition detecting unit and operating an inverse function for an identification of a head of the packet received by the security condition detecting unit during the initial networking between the client end and the server end.

17. The network security active detecting method of claim 16 wherein the security condition detecting unit determines the security level of the client end according to the comparison between an operating result of the identification of the head of the packet received by the security condition detecting unit and a predetermined progressive value.

18. The network security active detecting method of claim 10 wherein the communication protocol negotiated by the client end and the server end comprises a security service setting value.

19. The network security active detecting method of claim 18 wherein the security service routine comprises an encryption/decryption service, a digital signature service, or a pattern match service.

20. The network security active detecting method of claim 19 wherein the security service setting value of the encryption/decryption service comprises an encryption algorithm and a corresponding enciphering/deciphering key.
